(19) United States
(12) Patent Application Publication
(10) Pub. No.: US 2021/0228440 A1
(43) Pub. Date: Jul. 29, 2021

(54) METHOD FOR ACTIVATING MOTORS OF A MASSAGE DEVICE, WHICH IS PROVIDED IN A SEAT, IN PARTICULAR IN A VEHICLE SEAT, CONTROL DEVICE, AND SEAT ARRANGEMENT

(71) Applicant: BROSE FAHRZEUGTEILE GMBH & CO. KOMMANDITGESELLSCHAFT, COBURG, Coburg (DE)

(72) Inventors: Christian MERGL, Zeil/Main (DE); Wojciech FALINSKI, Coburg (DE); Wolfgang UEBEL, Weitramsdorf (DE); Christian KARL, Coburg (DE); Peter HORN, Bamberg (DE); Stefan BICKEL, Bamberg (DE); Alexander MUELLER, Bischberg (DE); Martin JUERGENLIEMK, Untersiemau (DE)

(73) Assignee: BROSE FAHRZEUGTEILE GMBH & CO. KOMMANDITGESELLSCHAFT, COBURG, Coburg (DE)

(21) Appl. No.: 16/314,290

(22) PCT Filed: Jun. 29, 2017
(86) PCT No.: PCT/EP2017/066094

§ 371 Date: Dec. 28, 2018

(30) Foreign Application Priority Data
Jun. 29, 2016 (DE) 10 2016 211 718.1

(51) Int. Cl. A61H 23/02; B60N 2/90

(52) U.S. Cl. CPC A61H 23/0263; B60N 2/976; A61H 2201/0149; A61H 2201/1207; A61H 2205/081; A61H 2201/1215; A61H 2023/0272; A61H 2203/0431; A61H 2201/5048

(57) ABSTRACT

The invention relates to a method for activating motors of a massage device provided in a seat, in particular a vehicle seat, wherein the activation of the motors is performed by a control unit on the basis of an acoustic entertainment signal, wherein a first motor and a second motor are activated as a pair, and wherein the activation of the motors of the pair is performed alternately. The invention further relates to a control unit, which is designed to control at least one pair of motors according to a method according to the invention, and to a seat arrangement for carrying out such a method.

### CROSS-REFERENCE TO RELATED APPLICATIONS

This application is the U.S. National Phase of PCT Application No. PCT/EP2017/066094 filed Jun. 29, 2017, which claims priority to German Patent Application No. DE 10 2016 211 718.1 filed Jun. 29, 2016, the disclosures of which are hereby incorporated in their entirety by reference herein.

### TECHNICAL FIELD

The present invention relates to a method for activating motors of a massage device provided in a seat, in particular a vehicle seat, and to a control unit for carrying out such a method and to a corresponding seat arrangement.

### BACKGROUND

Although applicable to any type of seats, the present invention and the problem underlying the invention will be explained in more detail by means of a vehicle seat.

There are massage systems for vehicle seats which allow a passenger to choose among different massage programmes. Such a massage system is described, for example, in DE 297 05530 U1.

Sometimes such massage systems are usually employed only temporarily. Hence lifespan requirements of such massage systems are substantially lower than for permanently operating vehicle components.

Currently efforts are being made to couple massage systems in a vehicle to other vehicle systems for improving driver experience. Such a concept has been described, for example, in DE 10 2015 109067 A1.

If a massage system is coupled to a vehicle system designed to have a long lifespan, for example an entertainment system of a vehicle, the lifespan requirements of the coupled components are thus different.

### SUMMARY

Against this background, an underlying idea of the present invention is to specify an improved method for activating motors of a massage device provided in a seat, in particular a vehicle seat.

Accordingly, the following is provided:
A method for activating motors of a massage device provided in a seat, in particular a vehicle seat, wherein the activation of the motors is performed by a control unit on the basis of an acoustic entertainment signal, wherein a first motor and a second motor are activated as a pair, and wherein the activation of the motors of the pair is performed alternately.
A control unit, which is designed to control at least one pair of motors according to a method according to the invention.
A seat arrangement for carrying out a method according to the invention, in particular for a vehicle, including: a seat, in particular a vehicle seat; a massage device provided in the seat; a first motor of the massage device; a second motor of the massage device; and a control unit according to the invention, wherein the first motor and the second motor are provided as a pair to be activated alternately by means of the control unit.

One of the ideas behind the present invention is to activate alternately motors of a massage device in pairs and thus adapt the lifespan of the massage device to an entertainment system. More particularly, the entertainment system is the source of the entertainment signal upon which the activation of the motors by the control unit is based.

In particular the massage device in the vehicle seat is coupled to an entertainment system of a vehicle. An entertainment system of a vehicle typically has a very high lifespan requirement as it is constantly running in the normal application case when the vehicle is operated. According to the invention, the lifespan of the massage device can now be adapted to the lifespan of the entertainment system by activating alternately the motors of the massage device so that it allows for a coupling throughout the entire lifespan in a functionally reliable manner.

To this end particularly several motors in a massage unit of the massage device may be provided and/or grouped so that the massage unit of the massage device is permanently operable also with alternating motors.

According to the invention, the increased lifespan is facilitated by means of conventional and/or unchanged electrical motors of a massage device. These may involve the most diverse types of rotation motors, for example, electric motors designed as brush motors or brushless motors, or special vibration motors, for example so-called LRA (Linear Resonant Actuator), CVM (Coin Vibration Motor), ERM (Eccentric Rotating Mass) actuators or the like. In particular more costly actuators for adapting the lifespan are advantageously dispensable.

In the case of rotation motors, the motors for example have a flywheel at their motor shaft. The acceleration and deceleration of the motor or the unbalance mass of the motor creates a resulting force which is perceived by a passenger of the seat and thus effects a massage.

The individual motors can each be, for example, an unbalance motor having an unbalance mass as a flywheel. Thus, a vibration can also occur due to the unbalance of the unbalance mass in the case of longer activations.

In a further embodiment, the motor can also be a motor having a flywheel with no unbalance at the motor shaft. For example, a rotationally symmetrical body is attached to the motor shaft for this purpose. In this case the acceleration and deceleration of the motor or the flywheel with no unbalance causes a restoring force or a restoring moment. Thereby vibrations can be generated by pulse-like or alternating activation of the motor and a resulting acceleration and deceleration of the motor.

For example, the massage device has a plurality of massage units integrated into the seat. Hereby the motors of different massage units can be activated as pairs or one pair of motors can be provided in a common massage unit and can be activated correspondingly.

The motors activated as a pair can be arranged especially close to each other, for example, adjacent to each other or right next to each other. That way, a passenger of the seat will be unable to differentiate which of the two motors of a pair is being activated and hence will not perceive the alternation.

In a further embodiment it is also conceivable that the motors activated as a pair are spaced apart from one another and/or are arranged at different sections of the seat. In this case, by skillfully coordinating the alternation of the motors, for example adapted to the entertainment signal, the alternation can be perceived by a passenger as part of the massage programme or as part of the massage based on the entertainment signal so that a deliberate alternation of individual motors is imperceptible for the passenger.

For activating the motors, a control unit distributes levels based on the entertainment signal such that not all motors of the massage device provided in a seat react to a level at the same time. Instead the levels are distributed alternately to the motors of a pair.

A motor can regularly be stopped for cooling by means of the alternation of the motors according to the invention, advantageously reducing wear, and thus increasing the lifespan. For example, the activated motors, respectively, are alternating so as to be adapted to the sequence of the levels of the entertainment signal, similar to the lights of a lighting console.

For example the motors are activated such that the cooling phases of individual motors can be integrated into a massage programme based on the entertainment signal so that the cooling phases of the motors are not perceived by the passenger to be disturbing. For example, the active motors or the activation of the same alternate at a rate or frequency which is not resolvable for the passenger in the context of the entertainment signal in combination with the massage. Hence despite the alternation and the cooling phases thus achieved, a uniform massage effect is obtained.

Advantageous configurations and developments emerge from the further dependent claims as well as the description with reference to the figures of the drawing.

According to one embodiment, the entertainment signal is based on a musical piece. In this case the activation of the motors of the pair is alternatingly performed in time to and in the rhythm of the musical piece. With the alternating time or rhythm of the music, the alternation appears to be a logic part of the massage adapted to the music for the passenger. Hereby the listening experience of the music is expanded by the massage transmitted by the seat. More particularly, the music provides an additional tactile sensation to a passenger in the form of a back and/or buttocks and/or neck and/or head massage, particularly on a large part of the body, by means of a plurality of massage units of the massage device integrated into the seat. Hence the music is felt altogether more intensely. Furthermore, the massage generated by the massage units is felt more intensely if the music is output at the same time via loudspeakers, because of the acoustic stimuli provided.

According to one development, the activation of the motors alternates with each beat or with the rhythm of the music. Hereby an adaptation of the massage to the style of the music and/or the current mood of the music is advantageously provided, and emotions expressed by a music can be transmitted in a tactile way by the seat. The alternation of the motors is thus logically embedded into the music.

According to one further embodiment, the activation of the motors of the pair is performed alternately according to a predetermined time interval, respectively. This way the times of activation of the cooling of the motors can be controllably activated and optimised.

According to one embodiment, at least a third and a fourth motor are activated as another additional pair. In this case the pairs of motors are each activated alternately in the same way. This way the principle according to the invention can be transferred to a plurality of pairs of motors, in particular a plurality of massage units of the massage device.

More particularly, in one embodiment the first and the second motor can be associated with a first massage unit of the massage device and the third and the fourth motor can be associated with another massage unit of the massage device. Needless to say that this may be transferred to a plurality of further massage units and further motors. This way the massage units of the massage device are operated the same way by activating their motors in pairs so that altogether a synchronous operation of the massage units is guaranteed.

The grouping of the pair of the first and second motors and the pair of the third and fourth motors into one massage unit of the massage device each, however, is not necessary for execution. Rather, the first and the second pair in one embodiment can also be motors of the massage device, distributed differently on the seat or motors provided in different massage units.

The same applies to one embodiment of a seat arrangement for which at least a third and a fourth motor of the massage device are provided which are provided for alternate activation as a further pair in the same way as the first and second motor.

According to one embodiment of the method for activating, the motors are activated alternately such that the alternation of the motors is undetectable and/or imperceptible for a passenger, particularly in the context of the entertainment signal. For example, the motors which are activated or which are active, respectively, alternate at a rate or frequency which is not detectable for the passenger in the context of the massage. Hence despite the alternation of the motors, a uniform massage effect is achieved without limitation of the passenger experience.

The above configurations and developments may be combined in any way, if appropriate. In particular the possible configurations of the method for activating motors of a massage device provided in a seat, in particular a vehicle seat, can be transferred both to a control unit designed to activate the motors and to a seat arrangement for such a method.

Further possible configurations, developments and implementations of the invention also comprise combinations not explicitly mentioned of features of the invention described previously or in the following with reference to the exemplary embodiments. In particular a person skilled in the art will also add individual aspects as improvements or additions to the respective basic form of the present invention.

### BRIEF DESCRIPTION OF THE DRAWINGS

In the following the present invention will be described in more detail based on the exemplary embodiments specified in the schematic figures of the drawing, in which:

FIG. 1 is a schematic illustration of a seat arrangement;

FIG. 2 is an exemplary acoustic entertainment signal;

FIG. 3 is an exemplary flowchart of an activation sequence;

FIG. 4A is a schematic illustration of a motor of a massage unit when acceleration from an initial position;

FIG. 4B is a motor according to FIG. 2A when decelerating;

FIG. 5 is a schematic side view of a seat arrangement according to a further embodiment with a passenger;

FIG. 6 is a schematic illustration of the location of a first and a second motor in a massage device according to a further embodiment; and

FIG. 7 is a block diagram of a further embodiment of a seat arrangement.

The accompanying figures of the drawing should convey a further understanding of the embodiments of the invention. They illustrate embodiments, and in connection with the description, help to explain principles and concepts of the invention. Other embodiments and many of the mentioned advantages arise in view of the drawings. The elements of the drawings are not necessarily shown to scale to each other.

In the figures of the drawings, elements, features and components which are alike, functionally identical and have the same effect are each provided with the same reference numerals.

### DETAILED DESCRIPTION

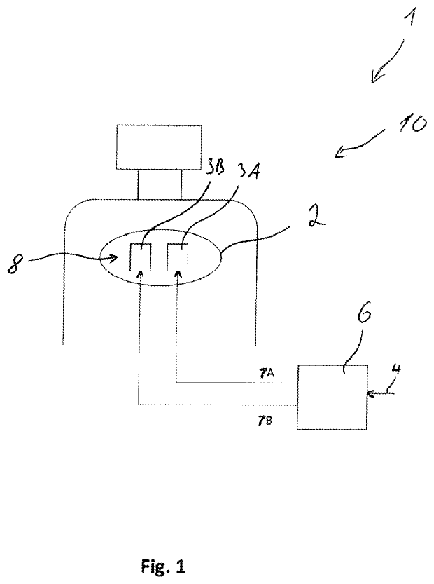

FIG. 1 shows a schematic illustration of a seat arrangement 1.

The seat arrangement 1 has a seat 10 which is designed as a vehicle seat. The seat 10 has a massage device 2 comprising a first motor 3A and a second motor 3B.

The shape and the positioning of the massage device 2 in the seat back 11 of the seat 10 as well as the arrangement of the motors 3A, 3B in the massage device 2 are to be understood merely schematically here. Various configurations and positioning of the massage device 2 as well as arrangements of the motors 3A, 3B are conceivable. More particularly, the massage device 2 can also be long or high instead of wide. Furthermore, instead of the motors 3A, 3B being arranged next to each other, an arrangement on top of each other or behind each other is conceivable as well. Moreover, the massage device 2 can extend into a seat base of the seat 10, optionally or in addition to the seat back 11.

Moreover, the seat arrangement 1 comprises a control unit 6, which is coupled to the first motor 3A and the second motor 3B of the massage device 2 for activation so that the first and the second motor 3A, 3B can be activated alternately as a pair 8 by means of the control unit 6.

The control unit 6 is configured such that the activation of the motors 3A, 3B based on an acoustic entertainment signal 4 can be performed as an input signal of the control unit 6. For example, the acoustic entertainment signal 4 may come from an entertainment device or playback means not shown, particularly an entertainment system of a vehicle.

During operation, the control unit 6 activates the motors 3A, 3B each with an output signal 7A, 7B based on levels of the entertainment signal 4. For example, the control unit 6 activates a motor 3A; 3B at a deflection of the level within a predetermined frequency range of the entertainment signal 4 for acceleration and a drop in the level when decelerating. Accelerating and decelerating the motor respectively leads to a resulting force at the massage device 2 which can be felt by a passenger of the seat 10 and causes a massage.

For reinforcement of the forces acting during acceleration and deceleration a motor 3A; 3B has a flywheel not shown herein in detail. This can be an unbalanced mass or a mass without balance. Due to the mass inertia thus increased, heightened reaction forces are caused when accelerating and decelerating which are used for massage.

The control unit is further configured such that the first motor 3A and the second motor 3B are always activated alternately as a pair 8. For this purpose, the activation of the motors 3A, 3B of the pair 8 is performed by means of alternate output signals 7A, 7B of the control unit 6.

For example, the activation of the motors is based on a musical piece as an entertainment signal 4. In this case the motors 3A, 3B of the pair 8 are activated such that they alternate to the beat or to the rhythm of the musical piece. While one of the motors 3A, 3B is accelerated or decelerated, the other motor is resting.

Beside from a musical piece, other types of entertainment signals 4 come into consideration for the activation. In further embodiments these can be, for example, a signal of a video clip, a movie, a console game or the like.

Particularly in the case of a vehicle seat 10, i.e. the application of the method for activating the motors in a vehicle, the playback means 5 can be, or can be coupled to, an entertainment system, e.g. containing a radio, a CD player, a DVD player, a Blu-ray player, an MP3 source, a game console or an on-board computer of the vehicle in question.

Finally, the acoustic entertainment signal 4, particularly regardless of an output volume adjusted at the playback means 5, can be used as primary signal or input variable for the activation. Needless to say that the acoustic entertainment signal 4 can also be adapted depending on the output volume of the playback means 5.

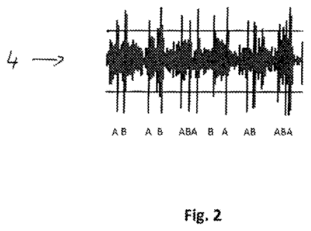

FIG. 2 shows the exemplary acoustic entertainment signal 4.

The entertainment signal 4 is the signal of a musical piece. Furthermore, the illustration of an exemplary activation sequence based on the levels of the signal is marked with the letters A and B.

The signal of a musical piece shown herein has a plurality of levels A, B. Such a signal is processed by the control unit 6 in one embodiment such that the motors 3A, 3B are activated alternately at each of the levels A, B. For this purpose, the level is converted into an output signal 7A, 7B, for example a motor current, for the motors 3A, 3B.

The levels are each marked alternately as A and B. Based hereupon the first motor 3A is activated particularly at every level A and the second motor 3B is activated at every level B.

A level A, B can each be a beat in the rhythm of the musical piece, for example. Hence an alternation of the activation of the motors 3A, 3B is performed with each beat to the rhythm of the music.

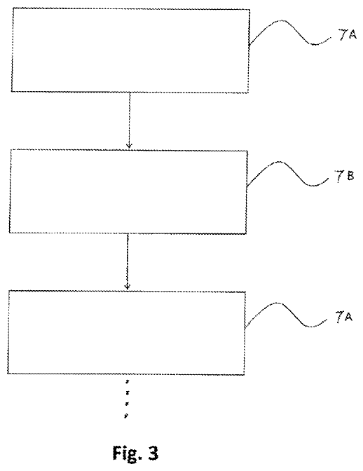

FIG. 3 shows an exemplary flowchart of an activation sequence.

The activation sequence comprises an alternating output of the output signals 7A, 7B which are each shown as a box. An output signal 7A is followed by an output signal 7B which in turn is followed again by the output signal 7A. This alternating signal sequence continues endlessly, as suggested by the dots, particularly as long as an entertainment signal 4 is present as an input signal and/or as long as the control unit is active or activated.

The output signals 7A, 7B can be alternated, as derived from the rhythm of the music of an entertainment signal, as shown in FIG. 2.

Yet in a further embodiment the motors 3A, 3B can also be activated alternately within predetermined time intervals. In this case the output signals 7A, 7B are alternating, particularly on a regular basis, within predetermined time intervals.

As already suggested with reference to FIG. 2 the output signals 7A, 7B are activation signals for the motors 3A, 3B, particularly a motor current or a motor control current.

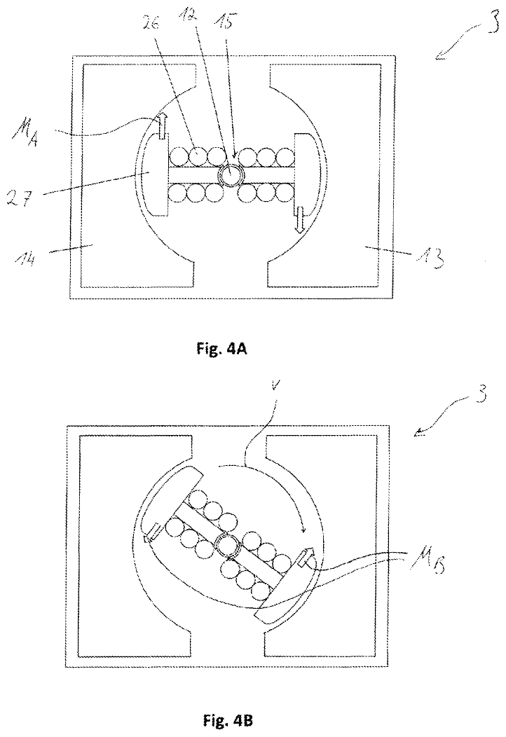

FIG. 4A shows a schematic illustration of a motor 3 of a massage device 2 during acceleration from an initial position.

The motor 3 shown here can be employed particularly as a first motor 3A or as a second motor 3B or as a further motor of a massage device 2.

The motor 3 is designed to be an electric motor, wherein one embodiment is shown herein as a permanently excited direct current machine merely by way of example. Other embodiments of an electric motor are possible as well. The motor 3 has a stator with two magnetic poles 13, 14 and a commutator 15 with sliding contacts which are not shown here for better clarity. The motor 3 generates a drive torque MA at a motor shaft 12 in a manner known to a person skilled in the art. To this end coils 16 which are provided on a rotor 17 or anchor connected to the motor shaft 12 are suitably supplied with current via the commutator 15.

For better clarity the drive torque MA is drawn here with two opposing arrows relative to the motor shaft 12 rather than directly at the motor shaft 12.

The position shown as an initial position is to be understood purely for illustration. In particular the initial position is not necessarily a position perpendicularly oriented to the poles but can also be another position.

After acceleration and subsequent deceleration, the motor 3 can be stopped so that it is at a standstill. At a standstill, the motor 3 is undriven and can cool down.

Furthermore, the motor 3, if activated by the control unit 6 in short intervals one after the other for accelerating and decelerating, can be stopped after completing a predetermined number of rotations or after a predetermined first length of time and can remain undriven for a predetermined second length of time. Should the motor 3, for example, be a first motor 3A of a pair 8 of motors 3A, 3B the second motor 3B of the pair 8 is activated during this second length of time.

A rotational direction of the motor 3 can be changed following a stop or with each new alternating activation of the first motor and the second motor. To this end a respective last rotational direction of the motor is stored and retrieved before accelerating so that the motor can be accelerated in the opposite rotational direction.

For activating the motor 3 an output signal 7 issuing from a control unit 6 is provided for accelerating to the rotational velocity v, here in the form of a motor current converted into an anchor current at the commutator.

FIG. 4B shows the motor according to FIG. 4A when decelerating from a rotational velocity v.

By accelerating the motor 3 or its rotor has a velocity or revolution per minute or rotational velocity v. For decelerating the motor 3 the anchor current applied to the coils 16 of the motor 3 can be commutated. That way the commutated current generates a brake moment MB which counteracts rotation.

Accordingly, a decelerating output signal 7 issuing from the control unit 6 for decelerating the motor 3 can be provided by commutating the motor current.

For better clarity the brake moment MB is drawn here with two opposing arrows relative to the motor shaft 12 rather than directly at the motor shaft 12.

In a further embodiment the motor 3 can also be short-circuited instead of being commutated for decelerating. In this case the control unit is designed to enable such a short-circuit temporarily, for decelerating a motor 3. Due to the short-circuit a current induced by the magnetic field of the stator in the coils 16 of the rotating rotor 17 generates a Lorentz force counteracting the rotation so that a braking moment MB is also applied to the motor shaft.

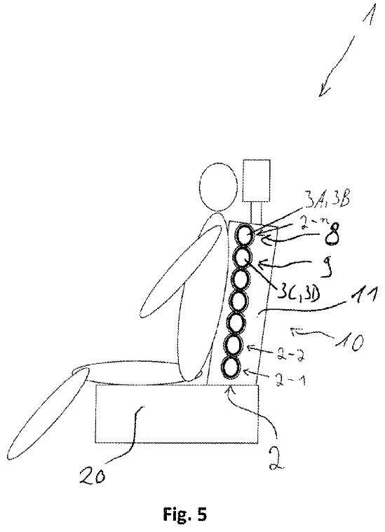

FIG. 5 shows a schematic side view of a seat arrangement 1 according to a further embodiment with a passenger.

The seat arrangement 1 comprises a seat 10 as well as a massage device 2. The seat has a seat base 20 at a seat back 11.

A plurality of massage units 2-1 to 2-n, integrated in the seat 10, of a massage device are provided in the seat back 11 which are activated accordingly by the control unit 6 which is not shown here for better clarity.

The massage units 2-1 to 2-n of the seat arrangement 1 are disposed herein by way of example over the seat back 11. Alternatively or additionally, massage units 2-1 to 2-n can also be disposed over the seat base 20 of the seat 10.

One of the massage units 2-1 to 2-n contains a first pair 8 of motors 3A, 3B of the massage device 2 which are not individually shown by symbols herein but each as part of the massage device. Another one of the massage units 2-1 to 2-n contains a further pair 9 of motors 3C, 3B of the massage device 2. The remaining massage units similarly contain further pairs of motors.

The control unit 6 distributes the levels for activating the motors 3A, 3B, 3C, 3D such that not all motors 3A, 3B, 3C, 3D of the massage units 2-1 to 2-n provided in the seat 10 react simultaneously to a level. Instead the control unit 6 distributes the levels such that the motors 3A, 3B; 3C, 3D of a pair 8; 9 alternate and can thus be stopped regularly for cooling down. Preferably the cooling phases of individual motors 3A, 3B, 3C, 3D are harmoniously integrated into the massage sequence so that the alternation of the motors 3A, 3B, 3C, 3D is imperceptible for the passenger.

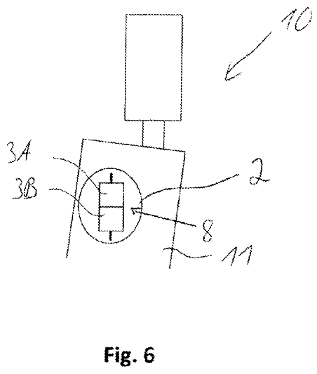

FIG. 6 shows a schematic illustration of the location of a first and a second motor 3A, 3B of a massage device 2 according to a further embodiment.

Here as well as in the object of FIG. 1 the massage unit 2 is arranged in a seat back of a seat 10. Here, too, there are two motors 3A, 3B activated as a pair 8.

As opposed to the embodiment according to FIG. 1, however, the motors 3A, 3B of the massage device 2 are arranged on top of each other. Also, the arrangement of the motors 3A, 3B shown herein is to be understood merely schematically. In particular arrangements of the motors 3A, 3B which are offset or adjacent or directly located adjacent to one another in other ways are conceivable.

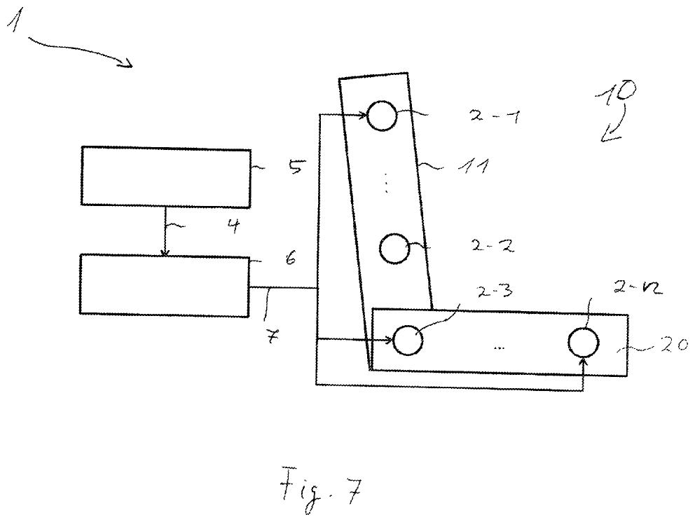

FIG. 7 shows a block diagram of a further embodiment of a seat arrangement 1.

The seat arrangement 1 has a seat 10, a playback means 5 and a control unit 6.

In the seat 10 a number of, i.e. one or more, massage units 2-1 to 2-n are arranged, herein specifically four, merely by way of example. In FIG. 4 the massage units 2-1 and 2-2 are arranged in the seat back 11 and the massage units 2-3 and 2-n in the seat base 20 merely by way of example. Further massage units 2 are indicated by three dots. The number and arrangement of the massage units 2 can be varied depending on the application.

Here, too, the control unit 6 is provided for the activation of the massage units 2-1 to 2-n. The control unit generates an output signal 7 from an entertainment signal 4 provided by the playback means 5, for example a musical piece, and derived from the playback means 5, for the motors of the massage units 2-1 to 2-n and transmits it to said massage units.

The output signal 7 comprises suitable control signals for pairs of motors contained in the massage units 2-1 to 2-n for the alternating activation of the same.

For example, the playback means 5 can be an audio system with a radio, CD player, MP3 player, video/DVD/Blu-ray player or the like installed in a vehicle. Yet the playback means 5 can be e.g. the audio system which receives the entertainment signal 4 via Bluetooth from e.g. a smartphone.

The control unit 6 can be provided integrated in the seat 10 either as an internal control unit 6 or it can merely be connected to the seat 10 as an external control unit 6. In the case of an external control unit 6 said unit can be provided, for example, integrated as a software module in an on-board network control unit, particularly a so-called body control unit, of a vehicle.

More particularly, the control unit 6 and the playback means 5 can also be grouped or integrated in one single control unit. For example, the control unit 6 can already be integrated in the vehicle audio system. Both the playback means 5 and the control unit 6 can at least in part be designed to be computer programme modules which are executed by a computing device of the audio system. In this case the motors of the massage units 2-1 to 2-n can likewise be coupled directly to the playback means 5.

Although the present invention has been fully described with reference to preferred exemplary embodiments, it is not limited thereto but can be modified in many different ways.

In particular an activation of motors as a pair does not necessarily mean a spatial arrangement of the motors in pairs. In fact, motors arranged at different locations of a seat can be motors activated as a pair. In particular the object of FIG. 7 can be provided as a pair 8, 9 of motors in different massage units 2-1 to 2-n.

The motors 3A, 3B can be activated alternately within predetermined time intervals in each of the embodiments rather than to the beat or to the rhythm of an entertainment signal 4.

1. A method for activating motors of a massage device provided in a seat,
wherein the activation of the motors is performed by a control unit on the basis of an acoustic entertainment signal,
wherein a first motor and a second motor are activated as a pair, and
wherein the activation of the motors of the pair is performed alternately.

2. The method of claim 1,
wherein
the entertainment signal is based on a musical piece and the activation of the motors of the pair is performed alternately to the beat and to the rhythm of the musical piece.

3. The method of claim 2,
wherein
the activation of the motors alternates with every beat of the bar or the rhythm.

4. The method of claim 1,
wherein
the activation of the motors of the pair is performed alternately according to a predetermined time interval.

5. The method of claim 1,
wherein
at least a third and a fourth motor are activated as a further pair and the pairs of motors are each activated alternately in the same manner.

6. The method of claim 1,
wherein
the motors are activated alternately such that the alternation of the motors is undetectable for a passenger.

7. A control unit which is designed for activating at least one pair of motors according to a method:
wherein the activation of the motors is performed by a control unit on the basis of an acoustic entertainment signal,
wherein a first motor and a second motor are activated as a pair, and
wherein the activation of the motors of the pair is performed alternately.

8. A seat arrangement for carrying out a method for activating motors of a massage device provided in a seat,
wherein the activation of the motors is performed by a control unit on the basis of an acoustic entertainment signal,
wherein a first motor and a second motor are activated as a pair, and
wherein the activation of the motors of the pair is performed alternately,
the seat arrangement comprising:
a seat, in particular a vehicle seat;
a massage device provided in the seat;
a first motor of the massage device;
at least a second motor of the massage device; and
a control unit which is designed for activating at least one pair of motors according to said method, wherein the first motor and the second motor are provided to be activated alternately as a pair by means of the control unit.

9. The seat arrangement of claim 12,
wherein
a third and at least a fourth motor of the massage device are provided which are provided to be activated alternately as a further pair similar to the first and second motor.

10. The method of claim 6,
wherein the alternation of the motors is undetectable for a passenger in the context of the entertainment signal.

11. The method of claim 1,
wherein the motors are activated alternately such that the alternation of the motors is imperceptible for a passenger.

12. The method of claim 8,
wherein the alternation of the motors is imperceptible for a passenger in the context of the entertainment signal.

13. The method of claim 1,
wherein the massage device provided in a vehicle seat.
